(19) United States
(12) Patent Application Publication
(10) Pub. No.: US 2012/0314680 A1
(43) Pub. Date: Dec. 13, 2012

(54) Method and Apparatus for Dynamically Modifying a Semi-Persistent Scheduling Allocation

(75) Inventor: Kalle Petteri Kela, Kaarina (FI)

(73) Assignee: NOKIA CORPORATION, Espoo (FI)

(21) Appl. No.: 13/581,302

(22) PCT Filed: Feb. 25, 2010
(86) PCT No.: PCT/FI2010/050140

§ 371 Date: Aug. 24, 2012

(51) Int. Cl. H04W 72/04; H04W 72/08

(52) U.S. Cl. 370/329

(57) ABSTRACT

In accordance with an example embodiment of the present invention, a network apparatus determines to modify an existing semi-persistent scheduling allocation and transmits scheduling instructions to a terminal. Upon receipt of the scheduling instructions, a terminal modifies the existing semi-persistent scheduling allocation by modifying a periodicity or by introducing a gap in transmission by skipping over one or more transmission opportunities.

### TECHNICAL FIELD

The present application relates generally to communications using scheduling, and in detail communications using semi-persistent scheduling.

### BACKGROUND

In communications, for example wireless cellular communications, terminals are allowed to send radio signals when resources such as frequency, time and/or spreading codes are allocated to them to prevent terminals from transmitting simultaneously using the same resources, which is known as a collision. Collisions may cause transmissions from terminals to interfere with one another, making communications more difficult.

Resources may be allocated using dynamic scheduling, which means that terminals request resources to be allocated to them each time they have data to send. Another allocation solution is persistent scheduling, which means that a terminal is given a fixed allocation, for example a certain length of time using certain, defined resources, which occurs with a set periodicity. The terminal may make use of this allocation to transmit data toward base stations or other nodes, including transmitting retransmissions for packets not successfully received over an air interface. A further allocation solution is semi-persistent scheduling, SPS, which means that a terminal is given a fixed allocation, for example a certain length of time using certain, defined resources, which occurs with a set periodicity. The terminal may make use of this allocation to transmit data toward base stations or other nodes, excluding transmitting retransmissions for packets not successfully received over an air interface. For retransmissions, the terminal requests resources to be allocated as needed.

### SUMMARY

Various aspects of examples of the invention are set out in the claims.

According to a first aspect of the present invention, there is provided an apparatus, comprising logic circuitry configured to cause, at least in part, the apparatus to participate in a communication using a semi-persistent scheduling allocation, memory configured to store parameters relating to the semi-persistent scheduling allocation, transceiver circuitry configured to receive scheduling instructions from a physical downlink channel, the logic circuitry being further configured to modify at least one of a periodicity parameter and a gap parameter relating to the semi-persistent scheduling allocation based at least in part on the scheduling instructions.

According to a second aspect of the present invention, there is provided a method, comprising participating in a communication using a semi-persistent scheduling allocation, storing parameters relating to the semi-persistent scheduling allocation, receiving scheduling instructions from a physical downlink channel and modifying at least one of a periodicity parameter and a gap parameter relating to the semi-persistent scheduling allocation based at least in part on the scheduling instructions.

According to a third aspect of the present invention there is provided an apparatus, comprising at least one processor, at least one memory including computer program code, the at least one memory and the computer program code configured to, with the at least one processor, cause the apparatus to perform at least transmitting scheduling instructions defining an initial semi-persistent scheduling allocation, determining to modify the initial semi-persistent scheduling allocation, and transmitting further scheduling instructions configured to modify at least one of a periodicity parameter and a gap parameter relating to the initial semi-persistent scheduling allocation.

The determination to modify the initial semi-persistent scheduling allocation may depend on at least one of: extent of use of the initial semi-persistent scheduling allocation, a quality of a communication based on the initial semi-persistent scheduling allocation and a level of interference in a cell.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example network capable of being operated according to principles of some embodiments of the invention.

FIG. 2 illustrates an example apparatus capable of supporting embodiments of the present invention.

FIG. 3 illustrates an example of semi-persistent allocations, and

FIG. 4 illustrates a flow chart of some embodiments of the invention.

FIG. 5 illustrates a flow chart of some embodiments of the invention from the network side.

### DETAILED DESCRIPTION OF THE DRAWINGS

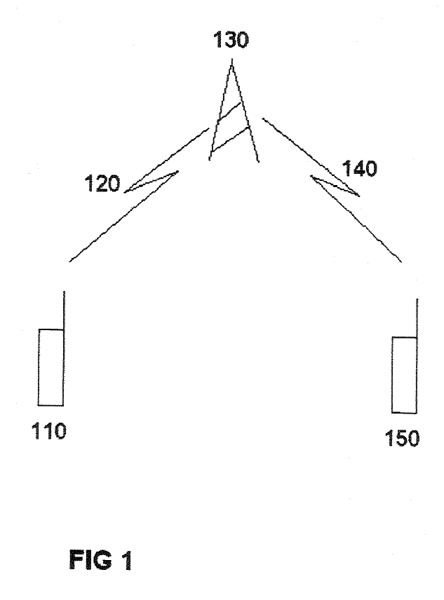

An example embodiment of the present invention and its potential advantages are understood by referring to FIGS. 1 through 5 of the drawings.

FIG. 1 illustrates an example network capable of being operated according to principles of some embodiments of the invention. Apparatus 110 may be, for example, a mobile phone, personal digital assistant, PDA, netbook, laptop or interface apparatus such as a wireless dongle. Apparatus 110 is capable of communicating with base station 130 using a radio link 120. Radio link 120 may be in accordance with, for example, long term evolution, LTE, industry standards. Other possible standards include wideband code division multiple access, WCDMA, and enhanced datarates for GSM evolution, EDGE, standards. Radio link 130 may comprise more than one standard, in which case it is a multi-access link. Base station 130 may be a base station, nodeB, eNB or wireless local area network, WLAN, access point, for example. Apparatus 150 may be similar to apparatus 110, and radio link 140 interconnecting the base station 130 and apparatus 150 may be similar to radio link 120. Radio links 120 and 140 may share radio resources such as frequency bands or spreading codes.

In order to prevent transmissions from apparatus 110 from colliding with transmissions from apparatus 150 when received at the base station 130, it may be desirable to schedule apparatus 110 and apparatus 150 to transmit at different times. Alternatively apparatus 110 and apparatus 150 may be directed to use dissimilar radio resources, such as frequency bands or spreading codes, which do not overlap so collisions are avoided even if apparatus 110 transmits at the same time as apparatus 150.

Radio links 120 and 140 may comprise uplink channels, whereby information is transmitted from apparatuses 110 and 150 to base station 130. Radio links 120 and 140 may also comprise downlink channels whereby information is transmitted from base station 130 to apparatuses 110 and 150. Apparatus 110 may receive its own downlink channels and apparatus 150 likewise its own downlink channels. A downlink channel may alternatively be shared, whereby both apparatuses 110 and 150 may receive the same downlink channel. Downlink channels may comprise data channels, whereby data relating to applications is transmitted, and control channels whereby control information is transmitted. Data relating to applications, or payload, may comprise encoded voice data or segments of file-sharing traffic, for example. Control information may comprise, for example, radio resource allocations, power control commands, transport format instructions, and the like. Radio resource allocations may comprise scheduling instructions which the base station 130 may use to implement persistent or semi-persistent scheduling. Scheduling instructions may comprise resources identifiers as well as periodicity and timing information. In dynamic scheduling, apparatus 110 or 150 needs a scheduling instruction each time it wants to send data, and in semi-persistent scheduling apparatus 110 or 150 receives a scheduling instruction each time it needs to re-transmit data by receiving from the network a negative acknowledgement, NACK. Re-transmission may comprise hybrid automatic repeat request, HARQ, retransmission, such as incremental redundancy or chase combining retransmission.

Control information may be sent on downlink control channels, for example a downlink control channel comprised in radio link 120 and/or 140. An example of a control channel is a physical downlink control channel, abbreviated as PDCCH. Control information, such as scheduling instructions, may be comprised in radio resource control, RRC, signaling in the control channels. In one embodiment, RRC parameters may be conveyed using a logical broadcast control channel, BCCH, in a physical downlink shared channel, PDSCH. Thus, responsive to receiving RRC signaling, an apparatus such as apparatus 110 and/or 150 may store in its internal memory parameters relating to a scheduling allocation defined by the scheduling instructions. Examples of such parameters include resources identifiers, periodicity information and timing information. Once an apparatus has taken a scheduling allocation into use, it may transmit information within the parameters defined by the allocation. This may comprise transmitting on a defined frequency band, using a defined modulation scheme, at a defined time recurring with a defined periodicity. A scheduling allocation may in some embodiments also comprise a channel coding scheme.

In some embodiments of the invention control information such as, for example, scheduling instructions may be comprised in a downlink data channel. An example of a downlink data channel is a physical downlink data channel, abbreviated as PDDCH. Another example of a downlink data channel is a physical downlink shared channel, PDSCH. It is possible that a scheduling allocation is first defined by sending scheduling instructions from base station 130 to apparatus 110 or 150 on a downlink control channel, and further scheduling instructions are sent later on a downlink control channel or a downlink data channel to modify parameters of the scheduling allocation. The scheduling allocation may first be defined using RRC signaling and the further scheduling instructions may be sent without using RRC signaling. In some embodiments the further scheduling instructions define a change in a periodicity relating to a defined semi-persistent scheduling allocation. In some embodiments the further scheduling instructions define a gap relating to a defined semi-persistent scheduling allocation. The gap may comprise that a transmission opportunity of a defined semi-persistent scheduling allocation is skipped. The gap may also comprise that several transmission opportunities of a defined semi-persistent scheduling allocation are skipped, in which case the further scheduling instructions define the number of opportunities to be skipped. Skipping a transmission opportunity means in this context that an apparatus does not use a defined transmission opportunity. It may be desirable to instruct apparatuses to skip transmission opportunities relating to a semi-persistent scheduling allocation if radio resources in a communications cell are crowded or if the utilization rate of the semi-persistent scheduling allocation is low, for example. An apparatus may respond to further scheduling instructions instructing a gap by buffering any data it would otherwise have sent in the affected transmission opportunities for transmission in transmission opportunities that occur in the scheduling allocation after the gap has ended. Modifying a semi-persistent scheduling allocation without using RRC signaling may conserve time and signaling since RRC signaling entails more delay and traffic than is strictly necessary to communicate the further scheduling instructions

The network that base station 130 is comprised in may be configured to monitor parameters relating to an active connection using a semi-persistent scheduling allocation from, for example, apparatus 110. The network may monitor the extent of use of the allocation. Responsive to determining that fewer resources are used than are allocated, meaning that the apparatus is only using a part of its allocation, the network may be configured to transmit further scheduling instructions to increase periodicity. Increasing periodicity means that a time interval between transmission opportunities is increased, so that transmission opportunities occur less frequently. Responsive to determining that allocated resources are fully or nearly fully used, meaning that the apparatus is using its allocation with little or no space capacity, the network may be configured to transmit further scheduling instructions to decrease periodicity. Decreasing periodicity means that a time interval between transmission opportunities is decreased, so that transmission opportunities occur more frequently. In this way, resources may be allocated more efficiently to apparatuses that actually need them. Responsive to determining that an interference level in a code division multiple access, CDMA, cell is higher than desired the network may send further scheduling instructions to either effect a gap or to increase periodicity. The level of interference may be compared to a threshold value to determine if it is higher than desired. Responsive to determining that communications quality has declined for a specific apparatus, the network may send further scheduling instructions to modify a modulation and/or coding scheme to a more robust one. A declined communications quality may be determined by determining that a frequency of retransmissions needed is increased compared to a previous frequency, or by determining that all packets are not successfully received even with retransmissions. As mobile terminals move about, they occasionally experience transiently adverse radio-path conditions that may not be able to properly support a modulation and/or coding scheme originally defined for a semi-persistent allocation using RRC signaling. For example, a 16-QAM modulation scheme may require a more reliable radio path than a 4-QAM modulation scheme. Once the network determines that the adverse radio conditions have subsided, for example by determining that substantially all transmissions from the terminal are correctly received without the use of retransmissions, it may send second further scheduling instructions to restore the original modulation and/or coding scheme.

Further scheduling instructions may be transmitted on a PDCCH channel with cyclic redundancy check, CRC, parity bits scrambled with SPS cell radio network temporary identity, C-RNTI. This way apparatus 110, for example, may recognize that the scheduling instructions relate to an SPS allocation and be able to separate the semi-persistent scheduling instructions from dynamic scheduling instructions or other traffic on the PDCCH channel. The channel may carry downlink control information, DCI, which comprises the further scheduling instructions. Similar information may also be transmitted to the apparatus using PDDCH and dedicated coding to indicate presence of further scheduling instructions.

In cases where apparatus 110, for example, has more than one active semi-persistent allocation it is possible that further scheduling instructions relate to all of the active semi-persistent allocations, or to a subset of all the active semi-persistent allocations. For example, further scheduling instructions may comprise instructions to effect a gap in all active allocations. As a second example, further scheduling instructions may comprise instructions to modify a periodicity of a single active allocation. As a third example, further scheduling instructions may comprise instructions to modify a periodicity of all active allocations the periodicities of which fulfill a criterion defined in the further scheduling instructions. Examples of such criteria are that the periodicity is at most a certain threshold value, or at least a certain threshold value, defined in the further scheduling instructions. Thus it may be achieved, for example, that periodicities of all semi-persistent allocations with transmission opportunities at most a certain time apart are modified, for example doubled or tripled.

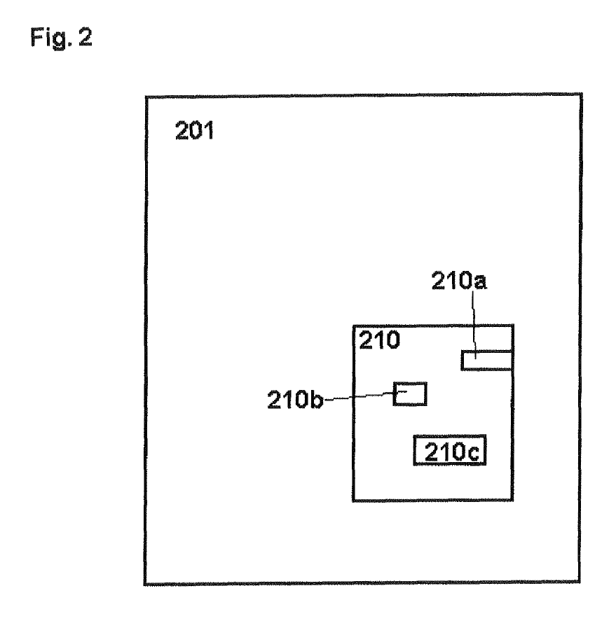

FIG. 2 illustrates an example apparatus 201 capable of supporting embodiments of the present invention. The apparatus may correspond to apparatus 110 or 150 of FIG. 1, for example. Base station 130 of FIG. 1 may also comprise similar elements. The apparatus is a physically tangible object, for example a cellular telephone, personal digital assistant, laptop, portable multimedia computer or other mobile apparatus. The apparatus may comprise a control apparatus 210, for example a digital signal processor (DSP), processor, field-programmable gate array (FPGA), application-specific integrated circuit (ASIC), chipset or controller. The apparatus may further comprise transceiver circuitry 210a configured to enable the apparatus 201 to connect to a network. The apparatus may comprise memory 210b configured to store information, for example information relating to received scheduling instructions. The memory may be solid-state memory, dynamic random access memory (DRAM), magnetic, holographic or other kind of memory. The apparatus may comprise logic circuitry 210c configured to access the memory 210b and control the transceiver circuitry 210a. The logic circuitry 210c may be implemented as software, hardware or a combination of software and hardware. The logic circuitry 210c may execute program code stored in memory 210b to control the functioning of the apparatus 201 and cause it to perform functions related to embodiments of the invention. The logic circuitry 210c may be configured to initiate functions in the apparatus 201, for example the sending of data units via the transceiver circuitry 210a. The logic circuitry 210c may be control circuitry. The transceiver circuitry 210a, memory 210b and/or logic circuitry 210c may comprise hardware and/or software elements comprised in the control apparatus 210. Memory 210b may be comprised in the control apparatus 210, be external to it or be both external and internal to the control apparatus 210 such that the memory is split to an external part and an internal part. If the apparatus 201 does not comprise a control apparatus 210 the transceiver circuitry 210a, memory 210b and logic circuitry 210c may be comprised in the apparatus as hardware elements such as integrated circuits or other electronic components. The same applies if the apparatus 201 does comprise a control apparatus 210 but some, or all, of the transceiver circuitry 210a, memory 210b and logic circuitry 210c are not comprised in the control apparatus 210.

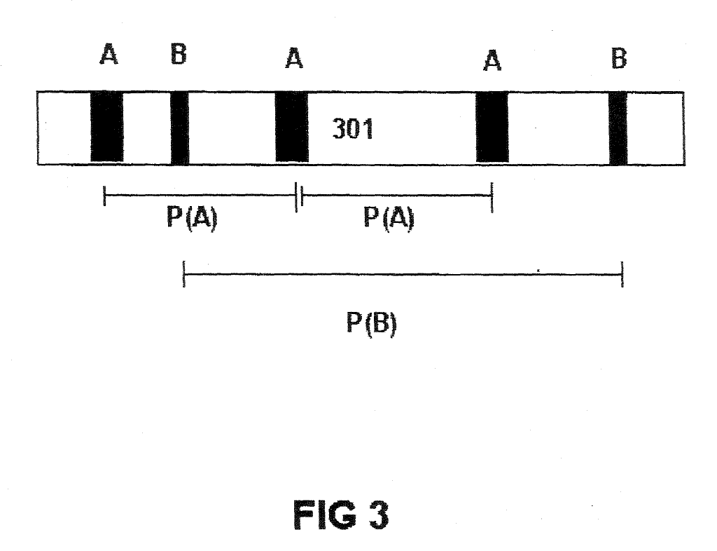

FIG. 3 illustrates an example of semi-persistent allocations. In the figure, time proceeds from left to right, and block 301 represents radio resources, for example radio frequency bands and/or spreading codes. The resource block is divided into time allocations, which may be of varying length and not all of which need to be allocated at any given time. Illustrated in the figure are two semi-periodic allocations, A and B. In the time frame illustrated lie three transmission opportunities of allocation A, marked with a capital “A” above block 301, and two transmission opportunities of allocation B, marked with a capital “B” above block 301. Allocation A comprises longer transmission opportunities than allocation B in this example, which is illustrated by the greater width of the transmission opportunities pertaining to allocation A in the figure. The periodicity intervals for allocation A and allocation B are illustrated as P(A) and P(B), respectively. In the example illustrated, allocation A has a shorter periodicity than allocation B.

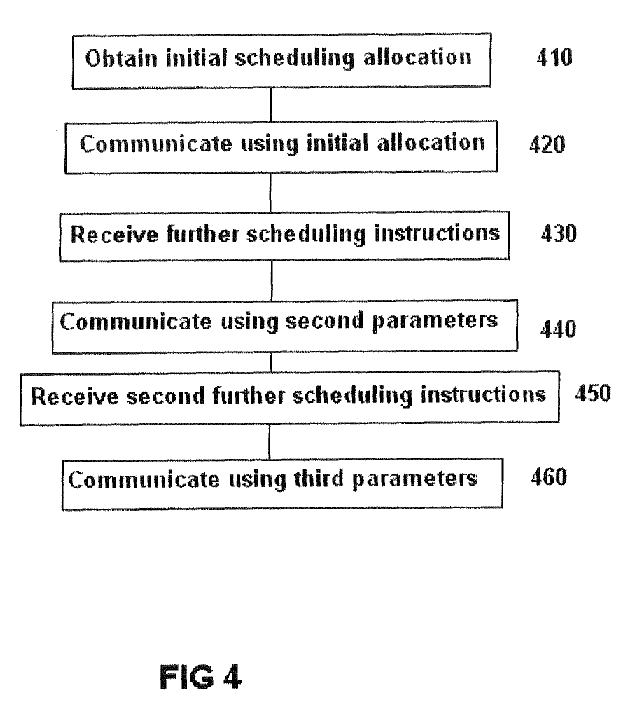

FIG. 4 illustrates a flow chart of some embodiments of the invention. In phase 410, an apparatus such as apparatus 110 or 150 of FIG. 1 receives an initial semi-persistent scheduling allocation. The initial allocation may be received, for example, via a downlink control or data channel and RRC signaling.

In phase 420 the apparatus communicates using an initial allocation defined by parameters received in scheduling instructions comprised in the initial scheduling allocation of phase 410. The received parameters may include parameters characterizing radio resources such as frequency band and/or spreading codes, timing, modulation, periodicity and channel coding parameters.

In phase 430, the apparatus receives further scheduling instructions. The further scheduling instructions may be received from a downlink control or data channel. The receiving may occur at a transceiver of apparatus 110 or 150, or at transceiver circuitry 210a comprised in a control apparatus 210, for example. The received instructions may have been transmitted from a network using a downlink control or data channel prior to being received at an apparatus or control apparatus, such that they have been transmitted from the network to the apparatus via such a channel. The further scheduling instructions may be received without using RRC signalling. The further scheduling instructions may comprise instructions to modify at least one of the parameters received in phase 410. For example, the further scheduling instructions may cause the apparatus to change a periodicity of a semi-persistent allocation in use, and/or effect a gap in the use of an allocation in use in the apparatus. The further scheduling instructions may relate to one or more allocations in use in the apparatus.

In phase 440 the apparatus communicates using a semi-persistent allocation defined by parameters received in initial scheduling instructions comprised in the initial scheduling allocation of phase 410, as modified by the further scheduling instructions received in phase 430.

In phase 450, the apparatus receives second further scheduling instructions. The second further scheduling instructions may be received in a downlink control or data channel. The second further scheduling instructions may be received without using RRC signalling. The instructions received in this phase may cause the apparatus to revert back to the initial scheduling allocation defined in phase 410, or to a third allocation state defined by the initial allocation as received in phase 410, as modified by the further scheduling instructions received in phase 430, as modified by the second further scheduling instructions received in phase 450. Phase 450 is optional.

In phase 460, the apparatus communicates using a third state, which as described above in connection with phase 450 may correspond to the initial allocation or to a third state different from the initial allocation and different from the initial allocation as modified by the further scheduling instructions received in phase 430. Phase 460 is optional. If phase 450 is not implemented, neither is phase 460.

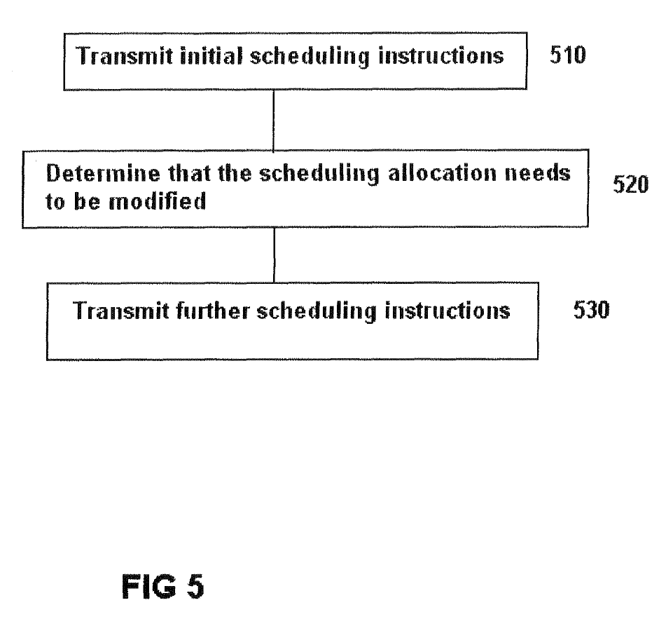

FIG. 5 illustrates a flow chart of some embodiments of the invention from the network side. In phase 510, an apparatus on the network side, for example base station 130 of FIG. 1, determines parameters relating to an initial semi-persistent scheduling allocation and transmits them to an apparatus, for example apparatus 110 or 150 of FIG. 1. The parameters may be comprised in initial scheduling instructions. This transmission may be effected using RRC signaling, for example. The apparatus on the network side need not be a base station. In some networks scheduling may be controlled by a base station controller, radio network controller or a core network node, for example. Subsequent to phase 510, communication is effected using the initial scheduling allocation.

In phase 520, the apparatus on the network side may determine, based on monitoring of the communication based on the initial scheduling allocation, that the initial scheduling allocation is to be modified. Considerations relating to this determination have been discussed above in connection with FIG. 1.

In phase 530, further scheduling instructions are transmitted to the apparatus, for example apparatus 110 or 150 of FIG. 1, from the apparatus on the network side. The further scheduling instructions may be configured to modify the initial allocation by changing a periodicity and/or effect a gap in communications, for example. Subsequent to phase 530, communication is effected using the initial scheduling allocation as modified by the further scheduling instructions.

Without in any way limiting the scope, interpretation, or application of the claims appearing below, a technical effect of one or more of the example embodiments disclosed herein is that quality of service relating to a wireless service can be managed more flexibly, as a faster and less cumbersome signaling method is used to effect changes in a semi-persistent allocation. Another technical effect of one or more of the example embodiments disclosed herein is that a level of interference in a CDMA cell can be managed by effecting gaps in semi-persistent allocations when the level of interference is considered to be too high. Another technical effect of one or more of the example embodiments disclosed herein is that effecting a change in modulation and/or channel coding can be used to improve communications reliability if, for example, a terminal experiences transiently adverse radio path conditions.

Embodiments of the present invention may be implemented in software, hardware, application logic or a combination of software, hardware and application logic. The software, application logic and/or hardware may reside on apparatuses 110, 150 and/or 201. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-15. (canceled)

16. An apparatus, comprising:
logic circuitry configured to cause, at least in part, the apparatus to participate in a communication using a semi-persistent scheduling allocation;
memory configured to store parameters relating to the semi-persistent scheduling allocation;
transceiver circuitry configured to receive scheduling instructions from a physical downlink channel; and
the logic circuitry being further configured to modify at least one of a periodicity parameter and a gap parameter relating to the semi-persistent scheduling allocation based at least in part on the scheduling instructions, wherein the scheduling instructions are received from a downlink control or data channel without employing radio resource control signaling.

17. An apparatus according to claim 16, wherein the gap parameter comprises a parameter instructing that at least one transmission opportunity of a defined semi-persistent scheduling allocation is to not be used.

18. An apparatus according to claim 17, wherein the scheduling instructions comprise an indication as to how many consecutive transmission opportunities are comprised in the gap.

19. A method, comprising:
participating in a communication using a semi-persistent scheduling allocation;
storing parameters relating to the semi-persistent scheduling allocation;
receiving scheduling instructions from a physical downlink channel; and
modifying at least one of a periodicity parameter and a gap parameter relating to the semi-persistent scheduling allocation based at least in part on the scheduling instructions, wherein the scheduling instructions are received from a downlink control or data channel without employing radio resource control signaling.

20. A method according to claim 19, wherein the gap parameter comprises a parameter instructing that at least one transmission opportunity of a defined semi-persistent scheduling allocation is to not be used.

21. A method according to claim 20, wherein the scheduling instructions comprise an indication as to how many consecutive transmission opportunities are comprised in the gap.

22. An apparatus, comprising:
at least one processor; and
at least one memory including computer program code
the at least one memory and the computer program code configured to, with the at least one processor, cause the apparatus to perform at least the following:
transmit scheduling instructions defining an initial semi-persistent scheduling allocation;
determine to modify the initial semi-persistent scheduling allocation; and
transmit further scheduling instructions configured to modify at least one of a periodicity parameter and a gap parameter relating to the initial semi-persistent scheduling allocation, wherein the further scheduling instructions are transmitted on a downlink control or data channel without employing radio resource control signaling.

23. An apparatus according to claim 22, wherein the determining is based on the extent to which the semi-persistent scheduling allocation is being used.

24. An apparatus according to claim 22, wherein the determining is based on comparing a level of interference in a cell to a threshold value.

25. An apparatus according to claim 22, wherein the determining is based on determining that a communications quality relating to a communication using the initial semi-persistent allocation has declined.

26. A computer program product comprising a computer-readable non-transitory medium bearing computer program code embodied therein for use with a computer, the computer program code comprising:
code for participating in a communication using a semi-persistent scheduling allocation;
code for storing parameters relating to the semi-persistent scheduling allocation;
code for receiving scheduling instructions from a physical downlink channel; and
code for modifying at least one of a periodicity parameter and a gap parameter relating to the semi-persistent scheduling allocation based at least in part on the scheduling instructions, wherein the scheduling instructions are received from a downlink control or data channel without employing radio resource control signaling.

27. A computer program product according to claim 26, wherein the gap parameter comprises a parameter instructing that at least one transmission opportunity of a defined semi-persistent scheduling allocation is to not be used.

28. A computer program product according to claim 27, wherein the scheduling instructions comprise an indication as to how many consecutive transmission opportunities are comprised in the gap.
